(19) United States
(12) Patent Application Publication
(10) Pub. No.: US 2003/0013332 A1
(43) Pub. Date: Jan. 16, 2003

(54) Structure of plug-in power supply apparatus

(76) Inventor: Chih-Chiang Lin, Taoyuan Shien (TW)

Correspondence Address: HOWARD J. KLEIN, KLEIN, O'NEILL & SINGH, 2 PARK PLAZA, SUITE 510, IRVINE, CA, 92614, US

(21) Appl. No.: 09/951,157

(22) Filed: Sep. 10, 2001

(30) Foreign Application Priority Data
Jul. 12, 2001 (TW) 090211753

(51) Int. Cl. H01R 13/44

(52) U.S. Cl. 439/131

(57) ABSTRACT

A structure of a plug-in power supply apparatus is disclosed. The power supply includes an insulating case, a circuit board and an AC inlet device. The structure of the power supply apparatus is characterized in that the power supply apparatus is detachably disposed in a receiving space of an electronic equipment, and the insulating case has at least one pair of a first conductive terminal for electrically connecting to the circuit board and the electronic equipment.

### FIELD OF THE INVENTION

The present invention relates to a structure of a power supply apparatus, and more particularly to a structure of a plug-in power supply apparatus detachably disposed in an electronic equipment.

### BACKGROUND OF THE INVENTION

The major function of an adapter is used for rectifying and transforming the commercial power source into a direct current (DC), which is employed by a power-receiving device such as printer and modem.

FIG. 1 is a diagram illustrating a structure of an adapter according to the prior art. As shown in FIG. 1, an adapter includes a case 11, a power cord 14, an AC inlet 12 and an internal circuit board (not shown). The circuit board is used for placing the electronic units thereon for rectifying and transforming. The AC inlet 12 is located at a first end 111 of the case 11 for receiving power source when the AC inlet 12 is electrically connected to a connector 161. Through a wire 162 and a plug 163, the AC inlet is electrically connected to a wall socket (not shown) for receiving the commercial power source. The second end 112 of the case 11 is used for outputting power source. Thus, the direct current (DC) is provided to the power-receiving device by the power cord 14.

Owing to the power cord 14 applied in the typical adapter, the following factors should be considered in the adapter design:

1. The material and manufacture of the power cord cost and the assembling of the power cord to the case costs;

2. When the adapter is not used, the power cord is required to be got together for preventing the wire from mess.

3. After producing the power cord, the power cord is required to pass the flexibility test, so the quality control cost is considerable.

Therefore, the purpose of the present invention is to develop a structure of a plug-in power supply apparatus to deal with the above situations encountered in the prior art.

### SUMMARY OF THE INVENTION

It is therefore an object of the present invention to provide a structure of a plug-in power supply apparatus without a power cord for reducing the material cost.

It is therefore another object of the present invention to provide a structure of a plug-in power supply apparatus without a power cord for reducing the quality control cost.

It is therefore an additional object of the present invention to provide a structure of a plug-in power supply apparatus without a power cord for reducing the assembling cost.

It is therefore an additional object of the present invention to provide a structure of a plug-in power supply apparatus detachably disposed inside an electronic equipment for saving the external space.

According to an aspect of the present invention, there is provided a structure of a power supply apparatus comprising an insulating case, a circuit board and an AC inlet device. The structure of the power supply apparatus is characterized in that the power supply apparatus is detachably disposed in a receiving space of an electronic equipment, and the insulating case has at least one pair of a first conductive terminal for electrically connecting to the circuit board and the electronic equipment.

For example, the electronic equipment is a printer.

Preferably, the power supply apparatus is an adapter.

For example, the AC inlet device is an AC inlet or an AC wire.

Preferably, the insulating case includes a top cover and a base.

Preferably, the electronic equipment has a second conductive terminal located at a first sidewall in the receiving space and at a relative position of the first conductive terminal of the insulating case.

Preferably, the insulating case has a protruding element closing to one end having the AC inlet device for taking out the insulating case from the electronic equipment.

Preferably, the insulating case further includes a sliding groove, and the electronic equipment has a protruding column located at a second sidewall in the receiving space and at a relative position of the sliding groove of the insulating case.

According to another aspect of the present invention, there is provided an adapter including an insulating case, a circuit board and an AC inlet device. The adapter is characterized in that the adapter is detachably disposed in a receiving space of a printer, and the insulating case has at least one pair of a first conductive terminal for electrically connecting to the circuit board and the printer.

Preferably, the printer has a second conductive terminal located at a first sidewall in the receiving space and at a relative position of the first conductive terminal of the insulating case.

For example, the AC inlet device is an AC inlet or an AC wire.

Preferably, the insulating case has a protruding element closing to one end having the AC inlet device for taking out the insulating case from the printer.

Preferably, the insulating case further includes a sliding groove, the printer has a protruding column located at a second sidewall in the receiving space and at a relative position of the sliding groove of the insulating case.

According to an additional aspect of the present invention, there is provided an electronic equipment assembly including an electronic equipment having a receiving space, and a power supply apparatus detachably plugged into the receiving space of the electronic equipment, and including an insulating case, a circuit board and an AC inlet device, wherein the insulating case has at least one pair of a first conductive terminal for electrically connected to the circuit board and the electronic equipment.

Preferably, the electronic equipment has a second conductive terminal located at a first sidewall in the receiving space and at a relative position of the first conductive terminal of the insulating case.

Preferably, the insulating case has a protruding element closing to one end having the AC inlet device for taking out the insulating case from the electronic equipment.

Preferably, the insulating case further including a sliding groove, and the electronic equipment has a protruding column located at a second sidewall in the receiving space and at a relative position of the sliding groove of the insulating case.

The present invention may best be understood through the following description with reference to the accompanying drawings, in which:

### BRIEF DESCRIPTION OF THE DRAWINGS

FIG. 1 is a diagram illustrating a structure of an adapter according to the prior art;

FIG. 2A is an assembly diagram illustrating a preferred embodiment of an adapter and a printer according to the present invention;

FIG. 2B is a composed diagram illustrating the combination of the adapter and the printer in FIG. 2A; and

FIG. 3 is an assembly diagram illustrating another preferred embodiment of an adapter and a printer according to the present invention.

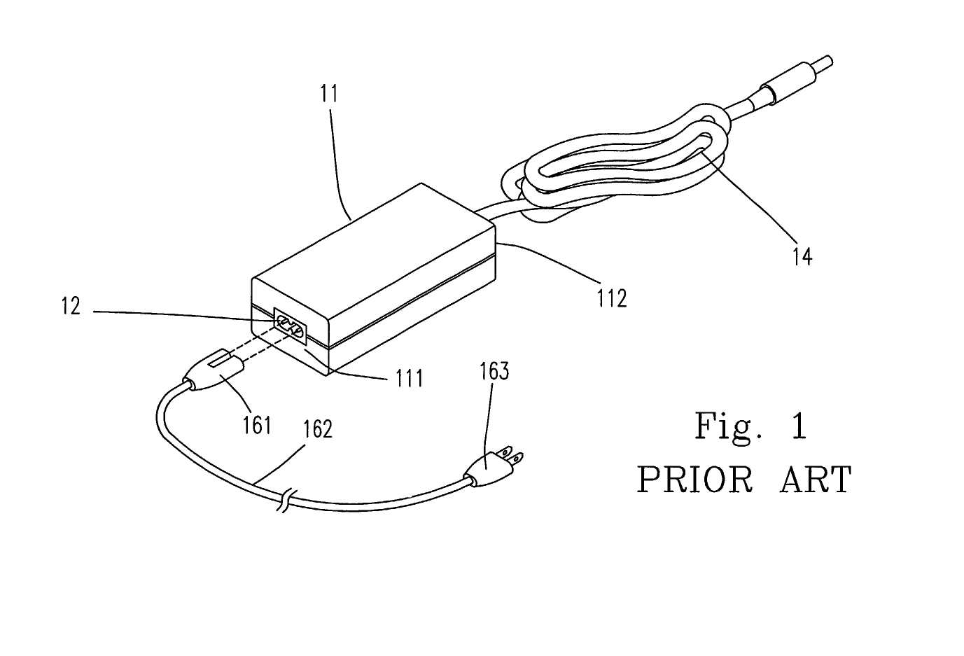

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

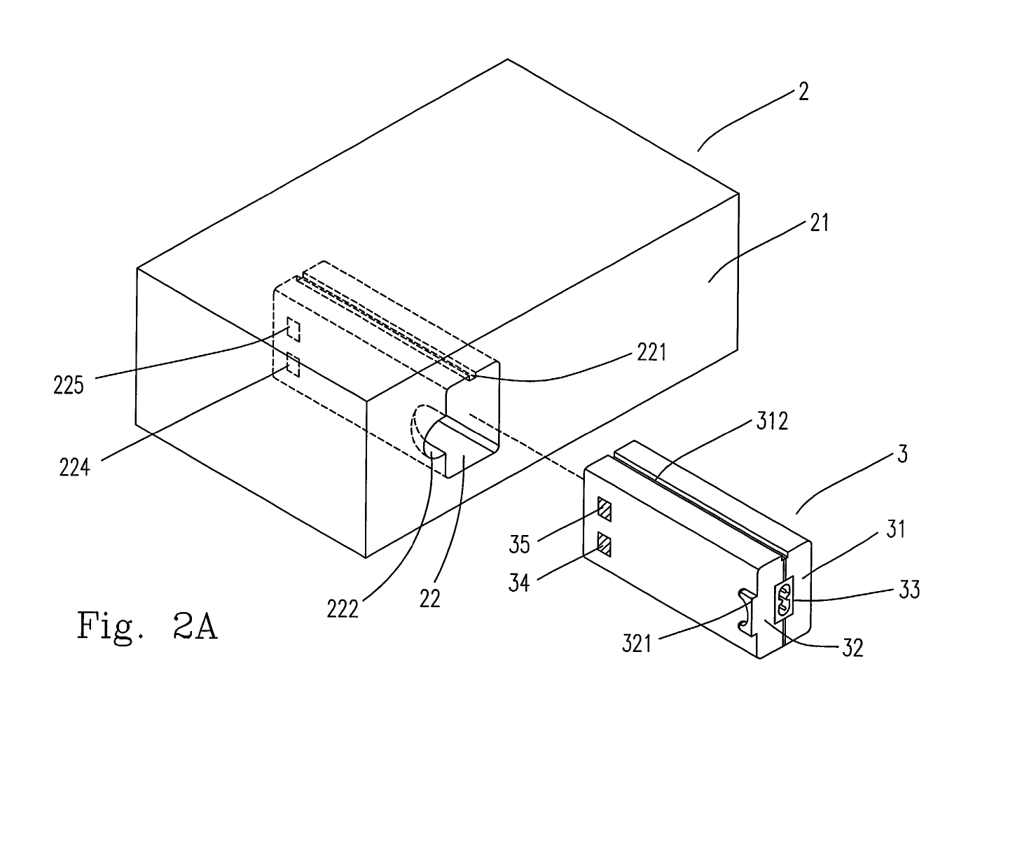

FIGS. 2A-2B are an assembly diagram and a composed diagram illustrating a preferred embodiment of an adapter and a printer according to the present invention, respectively. As shown in FIG. 2A, an adapter 3 includes an insulating case including a top cover 31 and a base 32, an AC inlet 33 and a first conductive terminal 34, 35. The AC inlet 33 is disposed between the top cover 31 and the base 32 and used for electrically connecting to a terminal (not shown) to further electrically connect to a socket (not shown). After receiving a commercial AC power source, a circuit board (not shown) inside the adapter 3 will rectify/transform the commercial AC power to a direct current (DC). The operation principle of rectification/transformation of the circuit board is the prior art, so it is not necessary to describe detail.

The present invention provides at least one pair of the first conductive terminals 34, 35 disposed on the base 32 for electrically connecting to the circuit board of the adapter 3, so the typical power cord applied in the adapter can be omitted. As shown in FIG. 2A, a substance 21 of a printer 2 has a receiving space 22 for receiving the adapter 3 therein. Corresponding to the first conductive terminals 34, 35, the substance 21 has a pair of second conductive terminals 224, 225 located at a first sidewall of the receiving space 22 for electrically connecting to an internal circuit (not shown) of the printer 2. Thus, when the adapter 3 plugs into the receiving space 22 as shown in FIG. 2B, the first conductive terminals 34, 35 are contacted with the second conductive terminals 224, 225 and the adapter 3 is electrically connected to the printer 2. Hence, the direct current rectified/transformed by the circuit board of the adapter 3 can be transferred to the printer 2. In addition, the number of the second conductive terminals is the same as that of the first conductive terminals.

For easily taking out the adapter 3 from the receiving space 22 of the printer 2, a protruding element 321 disposed close to the end having the AC inlet 33 for providing a pulling point. The shape of the protruding element 321 is dependent on the practice requirements, and the substance 21 also has a space 222 cooperated with the protruding element 321 for putting the finger therein.

Moreover, the insulating case of the adapter 3 further has a sliding groove 312 located at a jointed portion of the top cover 31 and the base 32. Furthermore, corresponding to the sliding groove 312, the printer has a protruding column 221 disposed at a second sidewall of the receiving space 22 for positioning the adapter 3.

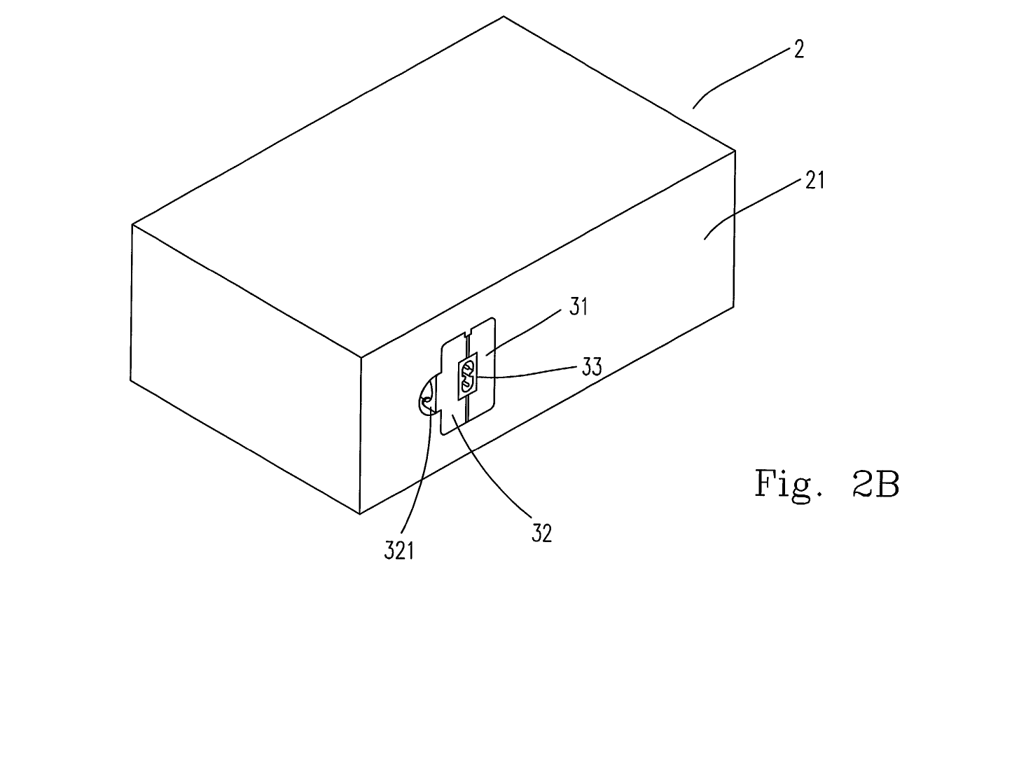

For another embodiment as shown in FIG. 3, the structures of the adapter 3 and the printer 2 are similar to those of the above embodiment except that an AC wire 33′ is directly used for receiving the commercial power instead of the AC inlet 33 in FIG. 2A.

In addition, the receiving space 22 of the printer 2 also can receive a battery (not shown) having the same size and similar structure as those of the power supply according to the present invention. Thus, the printer 2 can still work when there is no commercial power supply.

In sum, the present invention provides the structure of the plug-in power supply apparatus to solve the problems of the prior art because the typical power cord is omitted. Hence, the present invention can reduce the material cost, the quality control cost and the assembling cost. Moreover, the power supply apparatus is plugged into the receiving space of the electronic equipment, so it can reduce the space-consumption.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A structure of a power supply apparatus comprising an insulating case, a circuit board and an AC inlet device, characterized in that:
said power supply apparatus is detachably disposed in a receiving space of an electronic equipment; and
said insulating case has at least one pair of a first conductive terminal for electrically connecting to said circuit board and said electronic equipment.

2. The structure according to claim 1 wherein said electronic equipment is a printer.

3. The structure according to claim 1 wherein said power supply apparatus is an adapter.

4. The structure according to claim 1 wherein said AC inlet device is one of AC inlet and AC wire.

5. The structure according to claim 1 wherein said insulating case comprises a top cover and a base.

6. The structure according to claim 1 wherein said electronic equipment has a second conductive terminal located at a first side wall in said receiving space and at a relative position of said first conductive terminal of said insulating case.

7. The structure according to claim 1 wherein said insulating case has a protruding element closing to one end having said AC inlet device for taking out said insulating case from said electronic equipment.

8. The structure according to claim 1 wherein said insulating case farther comprises a sliding groove.

9. The structure according to claim 8 wherein said electronic equipment has a protruding column located at a second side wall in said receiving space and at a relative position of said sliding groove of said insulating case.

10. An adapter comprising an insulating case, a circuit board and an AC inlet device, characterized in that:
said adapter is detachably disposed in a receiving space of a printer; and
said insulating case has at least one pair of a first conductive terminal for electrically connecting to said circuit board and said printer.

11. The adapter according to claim 10 wherein said printer has a second conductive terminal located at a first side wall in said receiving space and at a relative position of said first conductive terminal of said insulating case.

12. The adapter according to claim 10 wherein said AC inlet device is one of AC inlet and AC wire.

13. The adapter according to claim 10 wherein said insulating case has a protruding element closing to one end having said AC inlet device for taking out said insulating case from said printer.

14. The adapter according to claim 10 wherein said insulating case further comprises a sliding groove.

15. The adapter according to claim 14 wherein said printer has a protruding column located at a second side wall in said receiving space and at a relative position of said sliding groove of said insulating case.

16. An electronic equipment assembly comprising:
an electronic equipment having a receiving space; and
a power supply apparatus detachably plugged into said receiving space of said electronic equipment, and comprising an insulating case, a circuit board and an AC inlet device,
wherein said insulating case has at least one pair of a first conductive terminal for electrically connected to said circuit board and said electronic equipment.

17. The electronic equipment assembly according to claim 16 wherein said electronic equipment has a second conductive terminal located at a first side wall in said receiving space and at a relative position of said first conductive terminal of said insulating case.

18. The electronic equipment assembly according to claim 16 wherein said insulating case has a protruding element closing to one end having said AC inlet device for taking out said insulating case from said electronic equipment.

19. The electronic equipment assembly according to claim 16 wherein said insulating case further comprises a sliding groove.

20. The adapter according to claim 19 wherein said electronic equipment has a protruding column located at a second side wall in said receiving space and at a relative position of said sliding groove of said insulating case.
